(19) United States
(12) Patent Application Publication
(10) Pub. No.: US 2016/0379268 A1
(43) Pub. Date: Dec. 29, 2016

(54) USER BEHAVIOR DATA ANALYSIS METHOD AND DEVICE

(71) Applicant: TENCENT TECHNOLOGY (SHENZHEN) COMPANY LIMITED, Shenzhen, Guangdong (CN)

(72) Inventors: Yajuan SONG, Shenzhen, Guangdong (CN); Yong LI, Shenzhen, Guangdong (CN); Lei XIAO, Shenzhen, Guangdong (CN); Jinjing LIU, Shenzhen, Guangdong (CN); Tao WANG, Shenzhen, Guangdong (CN); Xiaoping LAI, Shenzhen, Guangdong (CN); Jie WANG, Shenzhen, Guangdong (CN)

(73) Assignee: TENCENT TECHNOLOGY (SHENZHEN) COMPANY LIMITED, Shenzhen, Guangdong (CN)

(21) Appl. No.: 15/038,948

(22) PCT Filed: Feb. 10, 2015
(86) PCT No.: PCT/CN2015/072647

§ 371 Date: May 24, 2016

(30) Foreign Application Priority Data
Dec. 10, 2013 (CN) 201310670424.4

(51) Int. Cl. G06Q 30/02; G06N 99/00

(52) U.S. Cl. CPC G06Q 30/0269; G06Q 30/0255; G06N 99/005

(57) ABSTRACT

A user behavior data analysis method and device, used to accurately analyze user behavior and make advertising more targeted. The method comprises: obtaining behavior data generated in a data source after a user is registered with the data source (101), the data source containing behavior data respectively generated by all users registered with the data source, and the behavior data being data information recording the behavior of a user in the data source; extracting a user label from the behavior data of the user generated in the data source (102), the user label being information indicative of user behavior; obtaining preset directed population characteristics (103), the directed population characteristics being characteristics possessed by the population meeting the directed characteristics requirement; according to the behavior data of the user generated in the data source and the user label, extracting a target user group complying with the directed population characteristics from all users in the data source (104), the target user group comprising a plurality of users complying with the directed population characteristics.

This application claims the priority to Chinese Patent Application No. 201310670424.4 titled “USER BEHAVIOR DATA ANALYSIS METHOD AND DEVICE”, and filed with the Chinese State Intellectual Property Office on Dec. 10, 2013, which is incorporated herein by reference in its entirety.

### TECHNICAL FIELD

The disclosure relates to the field of computer technology, and in particular to a method and device for analyzing user behavior data.

### BACKGROUND

After a user registers with a data source, the user will perform various behaviors in the data source, such as commenting on website A, and ordering and paying for a commodity on website B. The data source will save behavior data of the user. In order to accurately describe a related behavior performed by the user in the data source, it is required to analyze the user behavior. Usually registration data and behavior data of the user are pre-processed, for example, the registration data and the behavior data are filtered, converted and integrated, and a user tag (tag) is extracted from the pre-processed user data.

After being extracted, the user tag may be matched with a preset interest category, and a matching degree between the user tag and the preset interest category is used to reflect the analyzed user behavior. Based on the analyzed user behavior, an advertiser can push an advertisement to users meeting a requirement of the advertiser, so as to promote products or services. In a common technical method, a calculation for similarity matching between the extracted user tag and a set standard interest is performed to categorize the user tag into the most accurate interest category, in this way, the user behavior is analyzed, and based on the analyzed user behavior, an advertisement is pushed to a user with an interest category meeting the requirement of the advertiser.

In the conventional technology, the user tag is extracted based on the registration data and behavior data of the user, and the calculation for similarity is performed only based on the extracted user tag and the set standard interest. However, the user behavior can not be completely reflected based on only the user tag, and thus the user behavior can not be accurately analyzed based on the calculated similarity between the user tag and the standard interest subsequently. In addition, different kinds of advertisers expect to push advertisements to different user groups. However, in the conventional technology, there is no difference between user tags matching with all interest categories, and objects to which the advertisement is pushed by the advertiser based on such analyzed user behavior are not targeted.

### SUMMARY

A method and a device for analyzing user behavior data are provided according to embodiments of the disclosure, to accurately analyze user behaviors and improve pertinence of objects to which the advertisement is pushed.

In order to address the above issue, the following technical solutions are provided according to embodiments of the disclosure.

In a first aspect, a method for analyzing user behavior data is provided according to an embodiment of the disclosure. The method includes:

obtaining behavior data generated by a use in a data source after the user registers with the data source, where the data source includes behavior data generated by each user that registers with the data source and the behavior data is data information recording a behavior of a user in the data source;

extracting a user tag from the behavior data generated by the user in the data source, where the user tag is information representing a behavior of the user;

obtaining a preset oriented audience characteristic, where the oriented audience characteristic is a characteristic of an audience meeting an oriented characteristic requirement; and

extracting a target user group meeting the oriented audience characteristic from all users in the data source, based on the behavior data generated by the user in the data source and the user tag, where the target user group includes multiple users meeting the oriented audience characteristic.

In a second aspect, a device for analyzing user behavior data is further provided according to an embodiment of the disclosure. The device includes:

a data obtaining processor, configured to obtain behavior data generated by a user in a data source after the user registers with the data source, where the data source includes behavior data generated by each user that registers with the data source and the behavior data is data information recording a behavior of a user in the data source;

a tag extraction processor, configured to extract a user tag from the behavior data generated by the user in the data source, where the user tag is information representing a behavior of the user;

a characteristic obtaining processor, configured to obtain a preset oriented audience characteristic, where the oriented audience characteristic is a characteristic of an audience meeting an oriented characteristic requirement; and

a user group extraction processor, configured to extract a target user group meeting the oriented audience characteristic from all user in the data source, based on the behavior data generated by the user in the data source and the user tag, where the target user group includes multiple users meeting the oriented audience characteristic.

It can be seen from the above technical solutions that, there are the following advantages according to the embodiments of the disclosure.

According to the embodiments of the disclosure, behavior data generated by a user in a data source is obtained after the user registers with the data source and a user tag is extracted from the behavior data generated by the user in the data source, then a preset oriented audience characteristic is obtained, and finally a target user group meeting the oriented audience characteristic is extracted from all users in the data source based on the behavior data generated by the user in the data source and the user tag. The extracted target user group includes multiple users meeting the oriented audience characteristic. The user behavior analysis can be performed on each user in the data source based on the behavior data generated by the user in the data source and the extracted user tag, which can improve the accuracy for the user behavior analysis. In addition, users meeting the requirement of the oriented audience characteristic may be extracted from all users in the data source based on the set oriented audience characteristic, and all the extracted users meeting the requirement of the oriented audience characteristic form the target user group. Since the oriented audience characteristic can be set based on different requirements of the advertiser, different target user groups are extracted based on different advertisement requirements. For advertisement pushing, the advertisement is pushed to only the target user group meeting the oriented audience characteristic, therefore pertinence of objects to which the advertisement is pushed is improved.

### BRIEF DESCRIPTION OF THE DRAWINGS

In order to illustrate the technical solutions according to embodiments of the disclosure clearer, the drawings to be used in the description of the embodiments are described briefly hereinafter. Apparently, the drawings described hereinafter are just some embodiments of the disclosure, and other drawings may be obtained by those skilled in the art according to those drawings.

FIG. 1 is a flow chart of a method for analyzing user behavior data according to an embodiment of the disclosure;

FIG. 2-a is a flow chart of a method for analyzing user behavior data according to another embodiment of the disclosure;

FIG. 2-b is a flow chart of an implementation of rule mining according to an embodiment of the disclosure;

FIG. 2-c is a flow chart of an implementation of model training according to an embodiment of the disclosure;

FIG. 3-a is a structural diagram of a device for analyzing user behavior data according to an embodiment of the disclosure;

FIG. 3-b is a structural diagram of a device for analyzing user behavior data according to another embodiment of the disclosure;

FIG. 3-c is a structural diagram of a device for analyzing user behavior data according to another embodiment of the disclosure;

FIG. 3-d is a structural diagram of a device for analyzing user behavior data according to another embodiment of the disclosure;

FIG. 3-e is a structural diagram of a device for analyzing user behavior data according to another embodiment of the disclosure;

FIG. 3-f is a structural diagram of a device for analyzing user behavior data according to another embodiment of the disclosure;

FIG. 3-g is a structural diagram of a device for analyzing user behavior data according to another embodiment of the disclosure;

FIG. 3-h is a structural diagram of a device for analyzing user behavior data according to another embodiment of the disclosure;

FIG. 4 is a structure diagram of a server to which a method for analyzing user behavior data is applied according to an embodiment of the disclosure.

### DETAILED DESCRIPTION OF THE EMBODIMENTS

A method and a device for analyzing user behavior data are provided according to embodiments of the disclosure, to accurately analyze user behaviors and improve pertinence of objects to which an advertisement is pushed.

The technical solution according to the embodiments of the disclosure will be described clearly and completely hereinafter in conjunction with the drawings according to the embodiments of the disclosure, to make the inventive object, features, and advantages of the invention clearer and more understandable. Apparently, the described embodiments are merely a few rather than all of embodiments of the disclosure. All other embodiments obtained by those skilled in the art based on the embodiments of the disclosure will fall within the protection scope of the disclosure.

Terms such as “first” and “second” in the specification, claims and forgoing drawings of the disclosure are only to distinguish similar objects, and are not used to describe specific sequence or order. It should be understood that, such terms can be interchanged as appropriate, and it is merely a way to distinguish objects having the same attributes in describing the embodiments of the disclosure.

Terms such as “first” and “second” in the specification, claims and forgoing drawings of the disclosure are only to distinguish similar objects, and are not used to describe specific sequence or order. It should be understood that, such terms can be interchanged as appropriate, and it is merely a way to distinguish objects having the same attributes in describing the embodiments of the disclosure. In addition, the terms ‘include’, ‘comprise’ and any variant thereof intend to cover a non-exclusive inclusion, thus a process, a method, a system, a product or a device including a series of elements is not limited to include these elements, but may also include other elements not clearly set out or intrinsic elements of the process, method, product or device.

Details are described in the following.

A method for analyzing user behavior data of a mobile device is provided according to an embodiment of the disclosure. The method may include: extracting a user tag from behavior data generated by a user in a data source, and extracting a target user group meeting an oriented audience characteristic from all users in the data source based on the behavior data generated by the user in the data source and the user tag. The target user group includes multiple users meeting the oriented audience characteristic.

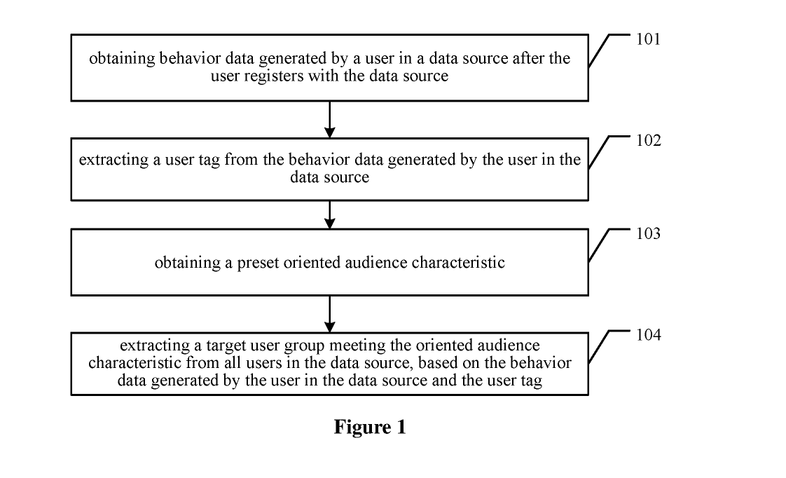

Referring to FIG. 1, a method for analyzing user behavior data is provided according to an embodiment of the disclosure. The method may include steps 101 to 104.

In 101, behavior data generated by a user in a data source is obtained after the user registers with the data source.

The data source includes behavior data generated by each user that registers with the data source, and the behavior data is data information recording a behavior of a user in the data source.

In the embodiment of the disclosure, the data source (Data Source) is a device or an original medium providing certain required data, i.e., a source of data. Information for establishing a database connection is stored in the data source, and a corresponding database may be found based on a data source name provided. The data source records behavior data of all users each of which registers with the data source.

After registering with the data source, the user will perform various behaviors on the data source, and the data source stores the behavior data of the user. Firstly a user tag is extracted from the behavior data generated by the user in the data source. A data source may include multiple pieces of behavior data generated by multiple users, and one user may generate multiple pieces of behavior data in multiple data sources. In the embodiment of the disclosure, there may be one or more data sources. In a case of multiple data sources, a weight is set for each data source based on the type of data generated in each data source, data authenticity in each data source and an evaluation result for each data source, and the behavior data generated by the user may be extracted from multiple selected data sources.

In 102, a user tag is extracted from the behavior data generated by the user in the data source.

The user tag is information representing behaviors of the user.

In the embodiment of the disclosure, the user tag may reflect the behavior data generated by the user in the data source. Multiple user tags may be extracted from multiple pieces of behavior data in one data source. Multiple user tags may also be extracted from multiple pieces of behavior data generated by one user in multiple data sources. The user tag may be obtained through extracting from behavior data generated by a user in a data source. It should be noted that, in the embodiment of the disclosure, the user tag may also be extracted based on registration data of the user in the data source and behavior data of the user in the data source.

In some embodiments of the disclosure, registration data and behavior data of the user in the data source may be pre-processed. For example, data migration may be performed to make the data migrate from multiple data sources to a hadoop cluster. Abnormal data cleaning may be performed, e.g., information such as messy codes is filtered out, and meaningless data is filtered. Data conversion may be performed, e.g., a character set is conversed into uniform codes, and source data is decoded. Data integration may be performed, e.g., all data sources are organized to a uniform format.

In some embodiments of the disclosure, word segmentation may be performed on the behavior data generated by the user in the data source, to extract a keyword as the user tag. The word segmentation refers to segmenting a sequence of Chinese characters into single words. The efficiency of the conventional word segmentation methods is very high. For an algorithm of a stand-alone version, a 50M document can be segmented within 20 minutes. For an algorithm of a Hadoop version, a 67G document (about 100 million records) can be segmented within 1 hour and 15 minutes.

In the embodiment of the disclosure, the keyword may be extracted based on a TFIDF improved algorithm. The main idea is that, if a term frequency (TF, Term Frequency) of a word or phrase appeared in the behavior data generated by the user is high and the TF of the word or phrase appeared in other behavior data is low, it is considered that the word or phrase have a good category distinguishing ability and is suitable for distinguishing different characteristics. In addition, an inverse document frequency (IDF) is used to measure general importance of a word. A high weight TFIDF may be generated for a word with a high term frequency in certain behavior data of a user and a low document frequency in the whole data source, and the word may be selected as a keyword of the user behavior data.

In 103, a preset oriented audience characteristic is obtained.

The oriented audience characteristic is a characteristic of an audience meeting an oriented characteristic requirement.

In the embodiment of the disclosure, obtaining a preset oriented audience characteristic refers to extracting a screening criterion to screen all users in the data source. Different oriented audience characteristics are obtained for different screening criterions. The oriented audience characteristic describes a characteristic possessed by an audience meeting the oriented characteristic requirement. The oriented audience characteristic is also set by considering the field to which the method for analyzing user behavior data according to the embodiment of the disclosure is applied. For example, if the method for analyzing user behavior data according to the embodiment of the disclosure is applied to advertisement pushing, the oriented audience characteristic meeting a requirement of an advertiser may be set in view that different advertisers raise different requirements on objects to which the advertisement is pushed. For example, if the advertiser is a manufacturer of maternal and baby products, the set oriented audience characteristic expected by the manufacturer of the maternal and baby products must be an audience of maternal and baby. If the advertiser is a manufacturer of game products, the oriented audience characteristic set for the manufacturer of the game products must be an audience interested in games. Therefore it is required to set the oriented audience characteristic based on specific application scenarios in the embodiment of the disclosure.

In 104, a target user group meeting the oriented audience characteristic is extracted from all users in the data source, based on the behavior data generated by the user in the data source and the user tag.

The target user group includes multiple users meeting the oriented audience characteristic.

In the embodiment of the disclosure, after the user tag is extracted from the behavior data generated by the user in the data source, the user behavior may be analyzed based on the behavior data generated by the user in the data source and the extracted user tag. For example, a system of user interests and hobbies, a user consumption capacity, a company on line that the user is interested in, or even marriage status of the user, may be analyzed based on the behavior data generated by the user and the user tag. By analyzing the user behavior based on the behavior data in combination with the extracted user tag, the accuracy for analyzing the user behavior of each user in the data source is improved, which is more accurate compared with analyzing the user behavior based on only a similarity between the user tag and the standard interest as in the conventional technology. In addition, each user in the data source may be analyzed based on the behavior data generated by the user and the user tag according to the set oriented audience characteristic, and the user meeting the oriented audience characteristic is included into the target user group. In this way, in view that different advertisers raise different requirements on objects to which the advertisement is pushed, an oriented audience characteristic meeting the requirement of the advertiser may be set, and a target user group is screened out based on the oriented audience characteristic expected by the advertiser. The advertisement is then pushed to users based on the target user group screened out in such a way, thereby improving pertinence of objects to which the advertisement is pushed and also meeting requirements of the users in time, and thus achieving a win-win situation for the advertisers and users. For example, if the advertiser is a manufacturer of maternal and baby products, the set oriented audience characteristic expected by the manufacturer of the maternal and baby products must be an audience of maternal and baby. In this case, in the embodiment of the disclosure, all users in the data source may be screened based on a set maternal and baby audience characteristic, to extract a target user group meeting the maternal and baby audience characteristic. For example, behavior data about purchasing a maternal and baby product by a user is extracted from the data source and behavior data about publishing a baby photo is extracted from the data source, in this case, user behavior analysis is performed on the behavior data and the user tag generating the behavior data. It may be obtained from the analysis that the user is a woman and the e-commerce category that she is interested in is maternal and baby products. In this way, the users meeting the maternal and baby audience characteristic are extracted into the target user group. Therefore, there is a strong pertinence for the advertiser to push advertisement information about maternal and baby products and related services to the extracted target user group. In addition, the users that receive the advertisement indeed focus on services related to maternal and baby, therefore the users may directly purchase the service on the advertisement without actively searching for information related to the maternal and baby services, which is convenient for the user.

It should be noted that, in the embodiment of the disclosure, the target user group meeting the oriented audience characteristic may be extracted from all users in the data source in many ways based on requirements of practical application scenarios of the disclosure. Details are described in the following.

In some embodiments of the disclosure, extracting the target user group meeting the oriented audience characteristic from all users in the data source based on the behavior data generated by the user in the data source and the user tag may include steps A1 to A3.

In A1, an oriented category is extracted from classified categories in the data source based on the oriented audience characteristic.

In A2, statistics is performed to determine the number of user behaviors, each of which with the user tag meeting the oriented category, in the data source.

In A3, users, each of which with the number of the user behaviors exceeding an oriented category threshold, in the data source, are extracted, to form a target user group. The target user group includes all users each of which with the number of the user behaviors exceeding the oriented category threshold.

Steps A1 to A3 describe extracting the target user group from all users in the data source in a manner of rule mining. In step Al, the oriented category meeting the requirement of the oriented audience characteristic is extracted from classified categories in the data source, i.e., for the requirement of the oriented audience characteristic, the oriented category is set based on the classified categories in the data source. One or more data sources may be selected. One or more oriented categories may be extracted based on the oriented audience characteristic. Usually fixed categories are already classified in the data source. For example, proprietary oriented categories may be sorted out in the data source based on types of forums, and special oriented channels are also set in some data sources, where the channels are classified into types such as digital, maternal and baby. In step A2, statistics is performed on user tags in the data source based on the oriented category, to determine the number of user behaviors each of which with the user tag meeting the oriented category, and the number of the behaviors of each user is taken as a score that the user meeting the oriented audience. In step A3, an oriented category threshold is set. By comparing the number of the user behaviors of each user obtained by the statistics with the oriented category threshold, the number of the user behaviors exceeding the oriented category threshold may be found and the user corresponding to the number of the user behaviors is extracted into the target user group.

It should be noted that in the embodiment of the disclosure, performing statistics to determine the number of the user behaviors, each of which with the user tag meeting the oriented category, in the data source in step A2 may include: calculating the number number of the user behaviors, each of which with the user tag meeting the oriented category, in the data source by using the following formula:

number=Σᵢ₌₁^{N}(λᵢ*Σⱼ₌₁^{M}countⱼ);

where N is number of data sources, λᵢ is a weight of an i-th data source, M is the number of oriented categories in the i-th data source, and count ⱼ is the number of user behaviors of the user in a j-th oriented category in each data source.

That is, in a case of multiple data sources, a weight may be assigned to each data source and the number of user behaviors in each oriented category in each data source is accumulated, thus the number of user behaviors of the user in all data sources can be obtained.

In some other embodiments of the disclosure, extracting the target user group meeting the oriented audience characteristic from all users in the data source based on the behavior data generated by the user in the data source and the user tag may include steps B1 to B4.

In B1, a keyword of the oriented audience characteristic is obtained based on the oriented audience characteristic.

In B2, the keyword is matched with the extracted user tag, and the number of all user behaviors, each of which with the user tag being matched with the keyword successfully, in the data source is calculated.

In B3, an oriented audience score of a user having the user behavior with the user tag being matched with the keyword successfully is calculated based on a forgetting factor and the number of all user behaviors, each of which with the user tag being matched with the keyword successfully, in the data source.

In B4, users, each of which with the oriented audience score exceeding an oriented audience correlation threshold, in the data source is extracted, to form the target user group. The target user group includes all users, each of which with the oriented audience score exceeding the oriented audience correlation threshold, in the data source.

Steps B1 to B4 describe extracting the target user group from all users in the data source in a manner of keyword matching. In step B 1, a keyword of the oriented audience characteristic is set based on a requirement of the oriented audience characteristic. The number of the keywords set based on the requirement of the oriented audience characteristic may be one, or may be more to form a keyword list. The keyword is obtained based on the requirement of the oriented audience characteristic, and the keyword may reflect the requirement of the oriented audience characteristic. For example, the oriented audience characteristic is an audience of maternal and baby, then the keyword that may be set for the audience of maternal and baby may be milk powder, baby, teether, and the like. After the keyword is obtained, the keyword is matched with the extracted user tag in step B2, to calculate the number of all user behaviors, each of which with the user tag being matched with the keyword successfully, in the data source. Upon that the keyword appears in the user tag, the keyword is matched with the user tag successfully, and the number of the user behaviors is incremented by 1. After the number of all user behaviors, each of which with the user tag of the user being matched with the keyword successfully, is calculated, a forgetting factor is set in step B3, and an oriented audience score of each user having a user behavior with the user tag being matched with the keyword successfully in the data source is calculated based on the forgetting factor and the number of all user behaviors, each of which with the user tag being matched with the keyword successfully, in the data source. In step B4, an oriented audience correlation threshold is set, the calculated oriented audience score is compared with the oriented audience correlation threshold, and users, each of which with the oriented audience score exceeding the oriented audience correlation threshold, in the data source, are selected as the target user group.

It should be noted that, in some embodiments of the disclosure, after step B1 of obtaining the keyword of the oriented audience characteristic based on the oriented audience characteristic, there is further a step of obtaining a filter word which is related to the keyword but is not matched with the oriented audience characteristic based on the obtained keyword. Matching the keyword with the extracted user tag and calculating the number of all user behaviors, each of which with the user tag being matched with the keyword successfully, in the data source in step B2 includes: matching the keyword and the filter word with the extracted user tag respectively, and calculating the number of all user behaviors, each of which with the user tag being matched with the keyword successfully but failing to be matched with the filter word, in the data source.

After setting the keyword based on the requirement of the oriented audience characteristic, a filter word which is related to the keyword but is not matched with the oriented audience characteristic may also be set. The filter word is a word that is related to the keyword but is not matched with the oriented audience characteristic. For example, the oriented audience characteristic is an audience of maternal and baby, then the keyword that may be set for the audience of maternal and baby may be milk powder, baby, teether, and the like. Words such as “digital baby” and “game baby” cannot be used as keywords and should be filtered out. Therefore, the word such as “digital baby” and “game baby” may used as the filter word. After the filter word is set, the keyword and the filter word may be matched with the extracted user tag respectively. In view that in matching with the user tag, both the keyword and the filter word may be successfully matched or fail to be matched with the user tag, it may be only calculated the number of all user behaviors, each of which with the user tag being matched with the keyword successfully but failing to be matched with the filter word, in the data source. That is, the number of the user behaviors is only calculated for the user tag that matches with the keyword successfully but fails to be matched with the filter word. By using the matching method of the keyword and the filter word, the number of user behaviors meeting the requirement of the oriented audience characteristic can be calculated more accurately, that is, the number of all user behaviors, each of which with the user tag being matched with the keyword successfully, in the data source subtracts the number of user behaviors, each of which with the user tag being matched with the filter word successfully, in the data source.

It should be noted that, in the embodiment of the disclosure, calculating the oriented audience score of each user having a user behavior with the user tag being matched with the keyword successfully in the data source based on the forgetting factor and the number of all user behaviors, each of which with the user tag being matched with the keyword successfully, in the data source in step B3 includes:

calculating the oriented audience score score of each user having the user behavior with the user tag being matched with the keyword successfully in the data source by using the following formula:

$$score = \frac{1}{1 + γ * exp [ - {\sum }_{begin \_ time}^{end \_ time} {\sum }_{i = 1}^{N} ( {λ}_{i} * {S}_{1} * F ( x ) ) / b ]} ;$$

where N is number of data sources, λᵢ is a weight of an i-th data source, Sᵢ is the number of user behaviors, each of which with the user tag being matched with the keyword successfully, in the i-th data source, F (X) is the forgetting factor,

$$F ( X ) = {e}^{- \frac{{lo g}_{2}^{( cur \text{-} est )}}{hl} ,}$$

cur is a current time when calculating score, est is a time when the user behavior is generated, hl is a half-life period, begin_time is a start time of the behavior data recorded in the data source, end_time is an end_time of the behavior data recorded in the data source, γ is a control parameter for a range of the oriented audience score, and b is a control parameter for an increment speed of the oriented audience score.

In some other embodiments of the disclosure, extracting the target user group meeting the oriented audience characteristic from all users in the data source based on the behavior data generated by the user in the data source and the user tag may include steps C1 to C4.

In C1, a training sample set is selected from all users in the data source based on the oriented audience characteristic.

In C2, a behavior characteristic is extracted from a user tag of a user in the training sample set. A characteristic value of the behavior characteristic is a term frequency-inverse document frequency (TF-IDF) of a word representing the behavior characteristic.

In C3, a categorization model is trained with the behavior characteristic using a categorization method.

In C4, all users in the data source are categorized by the categorization model, to obtain the target user group. The target user group includes all users screened out by the categorization model.

Steps C1 to C4 describe extracting the target user group from all users in the data source in a manner of model training. In step C1, a training sample set is selected from all users in the data source based on the oriented audience characteristic firstly. A standard training sample set may be firstly obtained based on the oriented audience characteristic. Users meeting a requirement of the oriented audience characteristic are obtained from the data source, and the accurately selected users may form the training sample set. In step C2, the behavior characteristic is extracted from the user tags of the users in the training sample set, and for the characteristic value of the behavior characteristic, the user may be represented by a vector through a vector space model. In step C3, the categorization model is trained with the extracted behavior characteristic using a categorization method. A specific categorization method may be a method of bayes or support vector machine (SVM), to obtain a categorization model meeting the specific audience characteristic. In step C4, all users in the data source are categorized by using the trained categorization model, to obtain all users which are screened out by the categorization model, and the target user group can be formed.

It should be noted that, in the embodiment of the disclosure, the term frequency-inverse document frequency (TF-IDF) is calculated by using the following formula:

$$TFIDF = \frac{tf ( t , d ) * {log}_{2} ( \frac{N}{{n}_{i}} + 0.01 )}{\sqrt{\sum {[ tf ( t , d ) * {log}_{2} ( \frac{N}{{n}_{i}} + 0.01 ) ]}^{2}}} ,$$

where tf (t,d) is the number of the user behaviors in the data source, t is a word representing the behavior characteristic, d is the behavior data in the data source, N is the number of user behaviors of all users, and nᵢ is the number of user behaviors of the user selected as the training sample set.

It should be noted that, several implementations for extracting the target user group from all users in the data source are described in the forgoing embodiments of the disclosure. Based on the implementations described in the embodiments of the disclosure, there may be other similar implementations. In addition, the target user group may be extracted by using only one of the forgoing implementations for extracting the target user group from all users in the data source. For example, the target user group may be extracted in a manner of rule mining, keyword matching, or model training. Alternatively, the target user group may be extracted in a manner of combining two or three of the implementations. The more fine the implementation, the more accurate the extracted target user group. For example, in step C1, for selecting the training sample set from all users in the data source based on the oriented audience characteristic, some accurate users may be selected in the data source in a manner of rule mining and then the training sample set is formed by these accurate users.

It should be noted that, in some embodiments of the disclosure, after step 102 of extracting the target user group meeting the oriented audience characteristic from all users in the data source based on the behavior data generated by the user in the data source and the user tag, the extracted target user group meeting the oriented audience characteristic may be further corrected, and the corrected target user group is recommended to the advertiser. The further correction to the target user group according to the embodiment of the disclosure may make the target user group more suitable to the requirement on the objects to which the advertisement is pushed expected by the advertiser, and the advertisers may push the advertisement with stronger pertinence. The target user group may be corrected in various ways according to the embodiment of the disclosure, such as an optimization on the user behavior data, and closed-loop iteration on the target user group. Details are described in the following.

In some embodiments of the disclosure, after step 103 of extracting the target user group meeting the oriented audience characteristic from all users in the data source based on the behavior data generated by the user in the data source and the user tag, there may be further steps D1 to D2.

In D1, an audience characteristic distribution of all users in the target user group is obtained.

In D2, a user in the target user group exceeding a characteristic distribution range of the audience characteristic distribution is filtered out, to obtain a first corrected target user group. The first corrected target user group includes users in the target user group within the characteristic distribution range of the audience characteristic distribution.

After the target user group is extracted, the audience characteristic distribution of all users in the target user group may be obtained in step D1. The audience characteristic distribution is analyzed. In step D2, a characteristic distribution range may be set, and the audience characteristic distribution of all users in the target user group is screened based on the set characteristic distribution range. For example, the oriented audience characteristic is an audience of maternal and baby and the extracted target user group includes multiple users. It is obtained that the audience characteristic distribution of the audience of maternal and baby is an age range from 22 to 30 and a sex ratio of men and women being 3:7, then it may be set that the characteristic distribution range is from 27 to 30, and all users in the target user group is screened based on the characteristic distribution range. The user exceeding the characteristic distribution range in the target user group is filtered out, and the remaining users form the first corrected target user group.

In some embodiments of the disclosure, after step 103 of extracting the target user group meeting the oriented audience characteristic from all users in the data source based on the behavior data generated by the user in the data source and the user tag, there may be further steps E1 to E2.

In E1, the behavior data generated by the user in the data source is updated.

In E2, the target user group meeting the oriented audience characteristic is corrected based on the updated behavior data, to obtain a second corrected target user group.

Specifically, correcting the target user group meeting the oriented audience characteristic based on the updated behavior data to obtain the second corrected target user group includes: extracting an updated user tag from the updated behavior data, and extracting multiple users meeting the oriented audience characteristic based on the updated behavior data and the updated user tag, to form the second corrected target user group.

In step E1, after the target user group is extracted, the behavior data generated by the user in the data source is updated, i.e., there is an update on the behavior data generated by the user in the data source. For example, a start time and an end_time for obtaining the behavior data in the data source are changed, then there is an update on the behavior data generated by the user in the data source after the period of time from the start time to the end_time is changed. In step E2, all users in the target user group meeting the oriented audience characteristic may be corrected based on the updated behavior data. For example, the oriented audience characteristic is an audience of maternal and baby, the extracted target user group includes multiple users, then the target user group is corrected based on the update of the behavior data in the data source after the target user group is mined out. For example, for a user of which the number of user behaviors within a month is more than two and of which the user behaviors appear in multiple data sources, the target user group meeting the oriented audience characteristic is corrected based on the updated behavior data, to obtain the second corrected target user group.

In some embodiments of the disclosure, after step 103 of extracting the target user group meeting the oriented audience characteristic from all users in the data source based on the behavior data generated by the user in the data source and the user tag, there may be further steps F1 to F3.

In F1, a correlation between multiple users in the target user group and the oriented audience characteristic is verified.

In F2, behavior data in a data source corresponding to a user, of which the correlation is less than a correlation threshold, in the target user group is corrected.

In F3, the target user group meeting the oriented audience characteristic is corrected based on the corrected behavior data, to obtain a third corrected target user group.

Specifically, correcting the target user group meeting the oriented audience characteristic based on the corrected behavior data to obtain the third corrected target user group includes: extracting a corrected user tag from the corrected behavior data, and extracting multiple users meeting the oriented audience characteristic based on the corrected behavior data and the corrected user tag, to form the third corrected target user group.

In step F1, the correlation between the target user group and the oriented audience characteristic is verified, i.e., the correlation between the extracted target user group and the set oriented audience characteristic is verified. For example, the target user group is recommended to an advertiser that sets the oriented audience characteristic, and the advertiser pushes an advertisement to all users in the target user group. It is determined whether the users in the target user group are high-quality users based on the oriented audience characteristic required by the advertiser and a real click rate of the advertisement pushed on line. If the users in the target user group actively click on the advertisement pushed by the advertiser, it may be determined that the correlation between the target user group and the oriented audience characteristic is high. In step F2, a correlation threshold is set to determine the level of the correlation. The click rate of the advertisement may be determined based on different data sources, and the behavior data in the data source with a low click rate is corrected. In step F3, the target user group meeting the oriented audience characteristic is corrected based on the corrected behavior data, to obtain the third corrected target user group. Therefore, based on the authentic test for the correlation between the target user group and the oriented audience characteristic, the correlation between the target user group and the oriented audience characteristic may be verified in a manner of closed-loop iteration, and the behavior data in the data source of which the correlation is less than the correlation threshold is corrected, to further improve the pertinence of objects to which the advertisement is expected to be pushed by the advertiser.

It can be known from the description of the embodiments of the disclosure that, behavior data generated by a user in the data source is firstly obtained after the user registers with the data source and a user tag is extracted from the behavior data generated by the user in the data source. A preset oriented audience characteristic is then obtained and finally a target user group meeting the oriented audience characteristic is extracted from all users in the data source based on the behavior data generated by the user in the data source and the user tag. The extracted target user group includes multiple users meeting the oriented audience characteristic. The user behavior analysis can be performed on each user in the data source based on the behavior data generated by the user in the data source and the extracted user tag, which can improve the accuracy for the user behavior analysis. In addition, users meeting the requirement of the oriented audience characteristic may be extracted from all users in the data source based on the set oriented audience characteristic, and all the extracted users meeting the requirement of the oriented audience characteristic form the target user group. Since the oriented audience characteristic can be set based on different requirements of the advertiser, different target user groups are extracted based on different advertisement requirements. For advertisement pushing, the advertisement is pushed to only the target user group meeting the oriented audience characteristic, therefore pertinence of objects to which the advertisement is pushed is improved.

In order to better understand and implement the forgoing solutions according to the embodiments of the disclosure, application scenarios are illustrated in detail in the following.

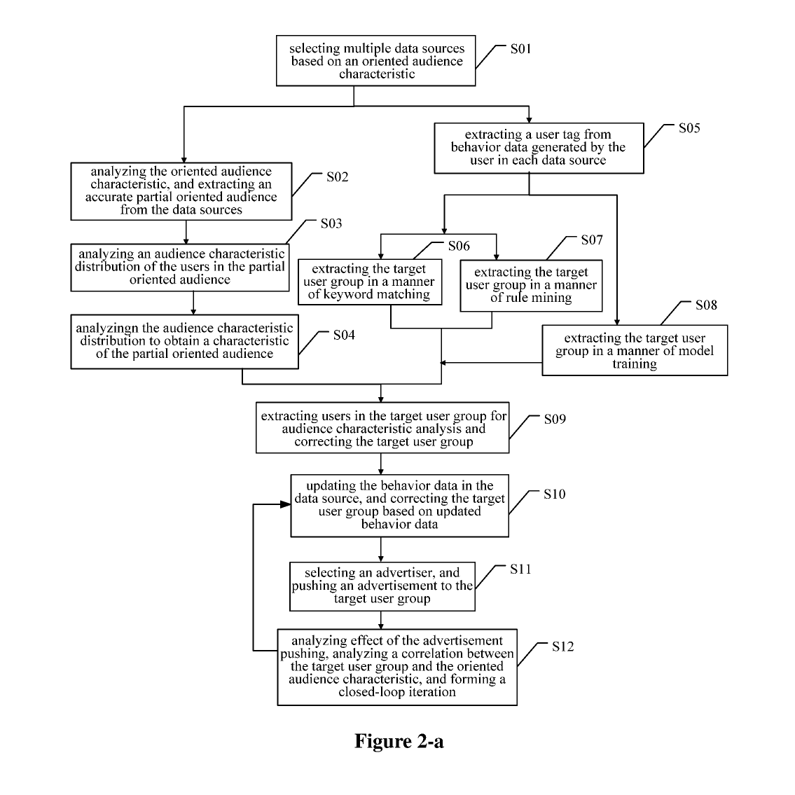

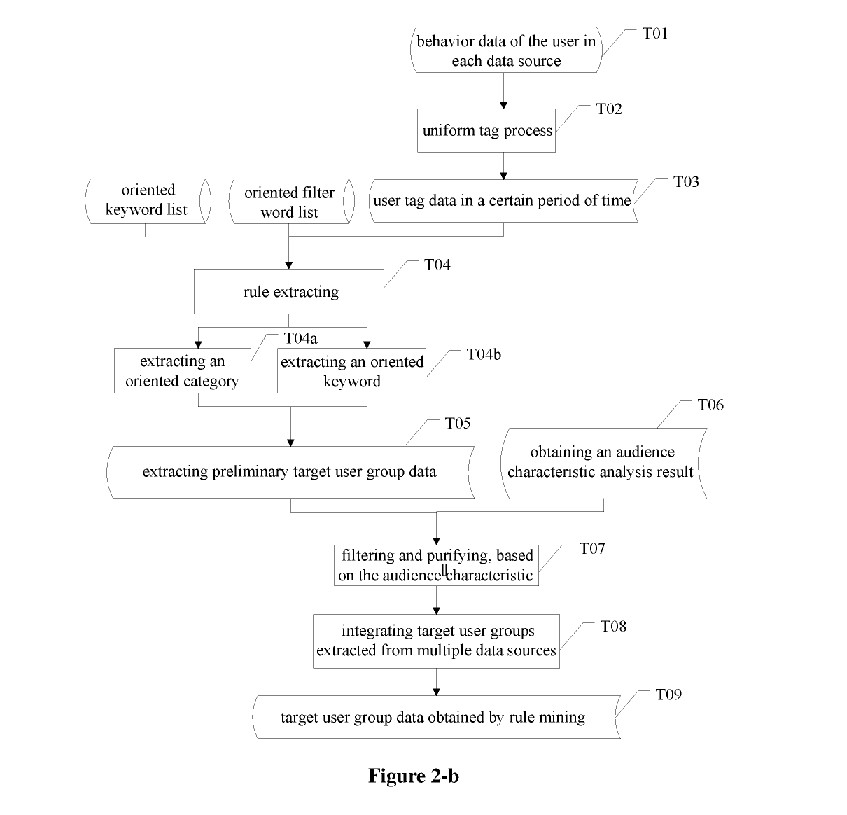

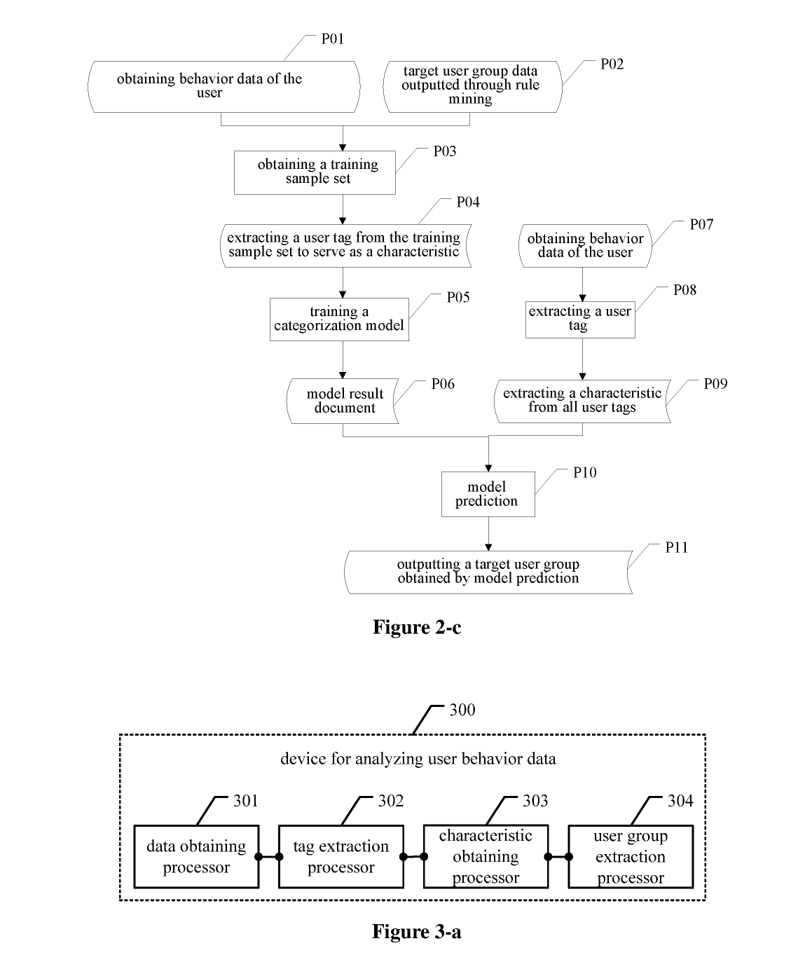

Referring to FIG. 2-a, which illustrates a flow chart of a method for analyzing user behavior data according to another embodiment of the disclosure. The method may include steps S01 to S12.

In S01, multiple data sources are selected based on an oriented audience characteristic.

For example, there are multiple data sources on a social platform, and each data source includes registration data and behavior data, but not all the data sources are suitable for mining of the oriented audience characteristic. Therefore, required data sources are selected from all the data sources for mining of the oriented audience characteristic. For example, there are multiple e-commerce data sources in view of a behavior of e-commerce. There are data sources such as interactive question and answer, social network and social user data in view of a behavior of interest. There are data sources such as instant speech issue, log and photo album for a behavior of user generated content (UGC).

After the multiple data sources are selected, step S02 and step S05 may be executed respectively.

In S02, the oriented audience characteristic is analyzed, and accurate partial oriented audience is extracted from the data sources. Then the process proceeds to step S03.

In S03, an audience characteristic distribution of users in the partial oriented audience is analyzed.

For example, the audience characteristic distribution of the users in the partial oriented audience is analyzed in multiple dimensions such as an age, a sex, an internet scenario, an education, a profession, and a social software usage activity.

In S04, the audience characteristic distribution is analyzed to obtain the characteristic of the partial oriented audience.

For example, in a case that the oriented audience is an audience of maternal and baby, the obtained characteristic of the partial oriented audience is that the age is between [25, 35], the sex ratio for men and women is 3:7, and the internet scenario is home and office.

In S05, a user tag is extracted from behavior data generated by the user in each data source.

For example, multiple users generate multiple pieces of behavior data in multiple data sources respectively, and the user tags such as a network game name, a teleplay name, and a movie name may be extracted.

After the user tags are extracted, different methods for extracting the target user group may be selected based on different data sources respectively. For example, steps S06, S07 and S08 are executed respectively.

In S06, the target user group is extracted in a manner of keyword matching. Then the process proceeds to step S09.

The manner of keyword matching is as follows. Firstly, a keyword list (different weight is set for each keyword) special for an oriented audience is set, and the user tags of the user in all the data sources are matched with the keyword list. Specifically, if a user tag includes a word which is in the special keyword list, calculation is performed based on a weight of this tag of the user and a weight of the matched special keyword, to obtain a score that the user tag of the user belongs to the oriented user group, and finally weighted calculation is performed to obtain the oriented user group.

In the keyword matching method, whether the user meets the oriented audience characteristic is determined based on the word in the user behavior, and the oriented audience score score of the user is mined out by using the keyword matching method:

$$score = \frac{1}{1 + γ * exp [ - {\sum }_{begin\_time}^{end\_time} {\sum }_{i = 1}^{N} ( {λ}_{i} * {S}_{i} * F ( x ) ) / b ]} ;$$

where N is the number of the data sources, λᵢ is a weight of an i-th data source, Sᵢ is the number of user behaviors, each of which with the user tag being matched with the keyword successfully, in the i-th data source, F (X) is the forgetting factor,

$$F ( X ) = {e}^{- \frac{{log}_{2}^{( cur \text{-} est )}}{hl}} ,$$

cur is a current time when calculating score, est is a time when the user behavior is generated, hl is a half-life period, begin_time is a start time of the behavior data recorded in the data source, end_time is an end time of the behavior data recorded in the data source, γ is a control parameter for a range of the oriented audience score, and b is a control parameter for an increment speed of the oriented audience score.

Sᵢ is the number of user behaviors of the user including a specific keyword in each data source, e.g., the number of online shopping transactions, the number of online shopping browses, the number of third-party payment transactions, the number of rebate jumps, the number of instant speech issues, and the number of times that a specific word appears in a social network album. The case that the oriented audience characteristic is an audience of maternal and baby is taken as an example. Firstly, a keyword list to mine the audience of maternal and baby is designated, such as N specific keywords of tag1, tag2, . . . , and tagn. Each piece of user behavior data of the user is traversed, and statistics is performed to determine whether the user behavior includes one or more words of tag1 to tagn and to determine the number of user behaviors including each word.

In addition, a method of keyword matching is selected. Some entries may be matched with the keyword but are not the required oriented audience characteristic. For example, baby is one of the keywords for the audience of maternal and baby, but words such as “digital baby” and “game baby” usually do not belong to the audience of maternal and baby. Therefore, a filter word list is introduced, to filter with a special word.

λᵢ is the weight of each data source. For example, a weight of transaction in data source A is high and a weight of brows in data source B is low. The value of the weight may be obtained by analyzing. For example, the weight of each data source for the audience of maternal and baby is extracted based on maternal and baby users extracted from each data source, and click rate data for a maternal and child advertisement is analyzed, to determine the weight of each data source.

hl is the half-life period, i.e., half of the user interest is forgotten after hl days. A rate for forgetting is firstly high and then low. hl may be tentatively set to 30 days currently based on data time and experience.

In S07, a target user group is extracted in a manner of rule mining. Then the process proceeds to step S09.

The manner of rule mining is as follows. An oriented channel, an oriented category is selected from existing categories in the data source, to obtain a target user group meeting the oriented audience characteristic. For example, in a statistical analysis network system, a list of proprietary oriented categories (such as digital, and maternal and baby) is sorted out based on types of forums. On a microblog, a proprietary oriented category “celebrity” is sorted out. On various online shopping platforms, there are special oriented channels. For a group, there are category types (such as digital, and maternal and baby). An oriented category is extracted from classified categories in the data source based on the requirement of the oriented audience characteristic.

Rule mining is to extract, for different data sources, a user group under specific categories. A score that the user belongs to the oriented group may be calculated by using a formula number=Σᵢ₌₁^{N}(λᵢ*Σⱼ₌₁^{M}countₗ),

where λᵢ is a weight of each data source, the weight of each data source is obtained through questionnaire, N is the number of the data sources, countⱼ, is the number of behaviors of a user under a designated category in each data source, and M is the number of oriented categories in the data source. For example, for extracting an oriented audience of maternal and baby, there are clicks in data sources A, B and C, i.e., N=3. The weight of data source A is λ₁, the weight of data source B is λ₂ and the weight of data source C is λ₃. In data source A, four categories, i.e., maternity clothing, child milk powder, child clothing, and baby walker, are sorted out through data analysis, i.e., M=4. Users under the four categories are extracted and statistic is performed to determine the number of user behaviors. An audience of maternal and baby and the score of each user in the audience of maternal and baby may be extracted by using the forgoing formula. In this method of rule mining, the mining is based on a rule and a statistical method, without operations such as model training and characteristic selecting.

In S08, the target user group is extracted in a manner of model training. Then the process proceeds to step S09.

In the manner of model training, the target user group meeting the oriented audience characteristic is extracted through text categorization. Details are described in the following.

A standard training sample set is selected. An oriented audience of rule extraction and a target oriented audience of questionnaire are taken as the training sample set currently. Accurate partial users are selected, and a behavior tag in each data source is taken as the characteristic. The user is represented by a vector through a vector space model after the characteristic is selected. A characteristic value of each characteristic is a TF-IDF value of a specific word, and TFIDF is calculated by using the following formula:

$$TFIDF = \frac{tf ( t , d ) * {log}_{2} ( \frac{N}{{n}_{i}} + 0.01 )}{\sqrt{\sum {[ tf ( t , d ) * {log}_{2} ( \frac{N}{{n}_{i}} + 0.01 ) ]}^{2}}} ,$$

where tf (t,d) is the number of user behaviors in the data source, t is a word representing the behavior characteristic, d is the behavior data in the data source, N is the number of user behaviors of all users, and nᵢ is the number of user behaviors of the user selected as the training sample set.

It is supposed that such training sample data is formed: lable \t feature1 featur2 feaure3 . . . featureN, and a categorization model is trained by using a method of bayes or a SVM (Support Vector Machine), to obtain a categorizer for an oriented audience. Result categories are an audience of maternal and baby, an audience of newlyweds, an audience of 3C digital, an audience of mobile phone, and the like.

To perform text categorization on other data source by the categorization model, a same method as extracting the characteristic of the training data may be applied to a user having an unknown categorization. The user characteristic is extracted from basic attribute data and behavior data of the user, and characteristic selection is performed. Each user is represented by a vector and categorized by a trained categorizer. Each user has a score for each oriented audience by means of the categorizer, and a user with a high score is extracted into the target user group by means of threshold limitation.

It should be noted that, three different methods for mining the target user group are provided in steps S06, S07 and S08 respectively. In practical applications, one, two or three of the methods may be selected for execution based on specific scenarios.

In S09, users of the target user group are extracted for audience characteristic analysis, and the target user group is corrected. Then the process proceeds to step S10.

For example, users accurately meeting the oriented audience characteristic are extracted. For example, for the maternal and baby group, multiple maternal and baby users are extracted, and the extracted group is considered as an accurate maternal and baby group. Characteristic distribution of the users in the maternal and baby group is analyzed in terms of attributes such as an age, a sex, a network scenario, an education, an income, and a pay ability. For example, for the analyzed maternal and baby group, the average age is about 27-30, the sex ratio for men and women is 3:7, and more than 85% of the internet scenarios is home.

Users beyond the characteristic distribution range are filtered out, to obtain a corrected target user group.

In S10, the behavior data in the data source is updated, and the target user group is corrected based on the updated behavior data. Then the process proceeds to step S11.

For example, data reliability is determined based on dimensions such as qualities of different data sources, different levels of sources, occurrence time and a weight of the number of behaviors, and secondary correction and optimization are performed. After the target user group is mined, the secondary correction is performed based on different data sources. For example, the correction is performed on user behavior data of users that have more than two behaviors within one month or have user behavior data in at least two data sources, and the accuracy of the target user group can be improved.

In S11, an advertiser is selected, and an advertisement is pushed to the target user group.

In S12, effect of advertisement pushing is analyzed, and a correlation between the target user group and the oriented audience characteristic is analyzed, and accordingly a closed-loop iteration is formed.

For example, ABtest verification may be adopted. Among all users in the target user group, only one factor is different and other factors are the same. One experiment is oriented, the other experiment is not oriented, and effects of the two experiments are compared to verify which effect is better. The effect may be user experience or a click rate. The relationship between the target user group and the type of the clicked advertisement is analyzed to primarily verify the accuracy of the data source, and in combination with online oriented pushing, a closed loop is formed for iteration and optimization. Whether the target user group is high-quality is determined based on the user characteristic required by the advertiser and the real click rate for the online pushed advertisement. The click rate of the advertisement may be determined based on different data sources, and a data source with a low click rate is optimized with emphasis.

With the method for analyzing user behavior data according to the embodiment of the disclosure, there are significant effects after the advertiser recommends the advertisement to the target user group meeting the oriented audience, such as increase of click rate, increase of conversion rate, and reduction of installation cost. The advertiser may achieve a significant effect for oriented advertisement recommending through a perfect orientation system.

Referring to FIG. 2-b, a flow chart of an implementation of rule mining according to an embodiment of the disclosure is illustrated, which may include steps T01 to T09.

In T01, behavior data of a user in each data source is obtained.

For example, the behavior data of the user is obtained from a distributed library list of a data source.

In T02, a uniform tag process is performed on the obtained behavior data. Then the process proceeds to step T03.

For example, the user generates multiple pieces of behavior data in multiple data sources respectively, and the user tag such as a network game name, a teleplay name and a movie name may be extracted.

In T03, user tag data within a certain period of time is obtained. Then the process proceeds to step T04.

The obtained user tag data includes a social software account of the user, a data source name, a corresponding tag, and a score of each tag.

In T04, rule extraction is performed based on an oriented keyword list, an oriented filter word list and the obtained user tag data, and then steps T04a and T04b are executed. Then the process proceeds to step T05 after steps T04a and T04b are executed.

The oriented keyword list and the oriented filter word list may be defined artificially.

In T04a, an oriented category is extracted.

For example, in a statistical analysis network system, a list of proprietary oriented categories (such as digital, and maternal and baby) is sorted out based on types of forums. On a microblog, a proprietary oriented category “celebrity” is sorted out.

In T04b, an oriented keyword is extracted.

The oriented keyword is fine-grained and is a specific tag for a certain oriented audience. For example, oriented keywords for an audience of newlyweds include “wedding dress”, “honeymoon tour”, “engagement party” and the like. The behaviors of the user may include these specific keywords. The oriented category is coarse-grained and is category data of a specific product. For example, a product of paipai has its own category system, and a user under a specific category is extracted in the category system of the product. For example, for an audience of newlyweds, specific categories under this product for a data source include “wedding celebration service”, “wedding photography”, and the like. For example, for an audience of maternal and baby, a specific category in the category system under this product for another data source is “parenting” channel.

In T05, preliminary target user group data is extracted. Then the process proceeds to step T07.

By extracting the oriented category and the oriented keyword, the preliminary target user group data that may be obtained includes a social software account of the user, a data source name, a corresponding tag and a score of each tag.

In T06, the user in the target user group is extracted for audience characteristic analysis, to obtain an audience characteristic analysis result. Then the process proceeds to step T07.

For example, a user accurately meeting the target user group characteristic is extracted. For example, for a maternal and baby group, multiple maternal and baby users are extracted, and the extracted group is considered as an accurate maternal and baby group. Characteristic distribution of the users in the maternal and baby group is analyzed in terms of attributes such as an age characteristic, a sex characteristic, a network scenario characteristic, an education, an income and a pay ability.

In T07, the preliminary target user group data is filtered and purified based on the audience characteristic. Then the process proceeds to step T08.

For example, the obtained characteristic of the maternal and baby group is: the average age is about 27-30, the sex ratio for men and women is 3:7, and more than 85% of the internet scenarios is home. The preliminary target user group data is filtered and purified.

In T08, target user groups extracted from multiple data sources are integrated. Then the process proceeds to step T09.

Integrated calculation may be performed based on a weight of each data source, a weight of the user tag, and a weight of a selected period of time.

In T09, target user group data mined out based on a rule is obtained.

Referring to FIG. 2-c, a flow chart of an implementation of model training according to an embodiment of the disclosure is illustrated, which may include steps P01 to P11.

In P01, behavior data of a user in each data source is obtained. Then the process proceeds to step P03.

In P02, target user group data mined out based on a rule is obtained. Then the process proceeds to step P03.

In P03, a training sample set is obtained based on behavior data in each data source and the target user group data mined out based on the rule. Then the process proceeds to step P04.

In P04, a user tag is extracted from the training sample set to be used as a characteristic. Then the process proceeds to step P05.

In the model training stage, training sample data is prepared, and oriented tags of the partial users are known. A tag with a high information gain is selected from behavior tags of the sample users, and is used as the characteristic for model training.

In P05, a categorization model is trained with the extracted characteristic. Then the process proceeds to step P06.

In P06, a model result document is outputted based on the categorization model. Then the process proceeds to step P10.

In P07, behavior data of the user in each data source is obtained. Then the process proceeds to step P08.

In P08, a user tag is extracted from behavior data in each data source. Then the process proceeds to step P09.

In P09, a characteristic is extracted from all user tags. Then the process proceeds to step P10.

In P10, model prediction is performed based on the model result document and the extracted characteristic. Then the process proceeds to step P11.

In P11, a target user group obtained by model prediction is outputted.

It can be known from the description of the forgoing embodiments of the disclosure that, the user tag is extracted from the behavior data generated by the user in the data source firstly, and then the target user group meeting the oriented audience characteristic is extracted from all users in the data source based on the behavior data generated by the user in the data source and the user tag. The extracted target user group includes multiple users meeting the oriented audience characteristic. The user behavior analysis can be performed on each user in the data source based on the behavior data generated by the user in the data source and the extracted user tag, which can improve the accuracy for the user behavior analysis. In addition, users meeting the requirement of the oriented audience characteristic may be extracted from all users in the data source based on the set oriented audience characteristic, and all the extracted users meeting the requirement of the oriented audience characteristic form the target user group. Since the oriented audience characteristic can be set based on different requirements of the advertiser, different target user groups are extracted based on different advertisement requirements. For advertisement pushing, the advertisement is pushed to only the target user group meeting the oriented audience characteristic, therefore pertinence of objects to which the advertisement is pushed is improved.

It should be noted that, for simplicity of description, the forgoing method embodiments are expressed as a combination of a series of actions. Those skilled in the art should know that, the disclosure is not limited to the described action sequence, and some steps may be performed in other sequences or performed simultaneity according to the embodiments of the disclosure. Those skilled in the art should also know that, the embodiments in the disclosure are preferable embodiments, and the related actions and processors are not necessarily required in the invention.

In order to better implement the forgoing solutions according to the embodiments of the disclosure, a related device to implement the forgoing solutions is provided.

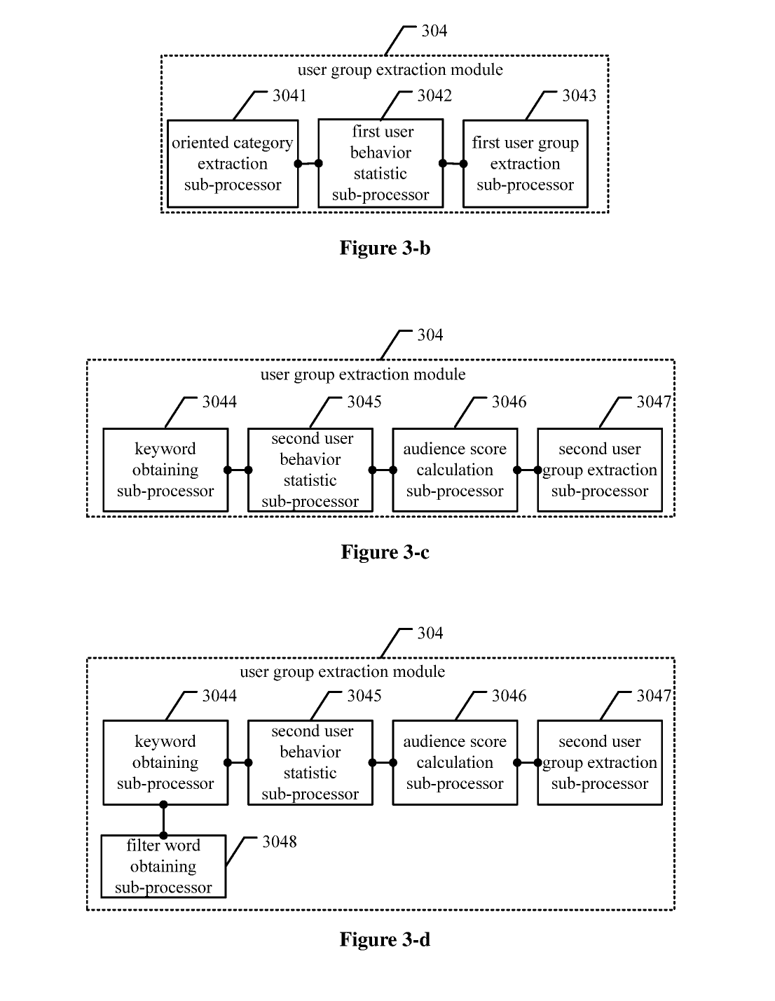

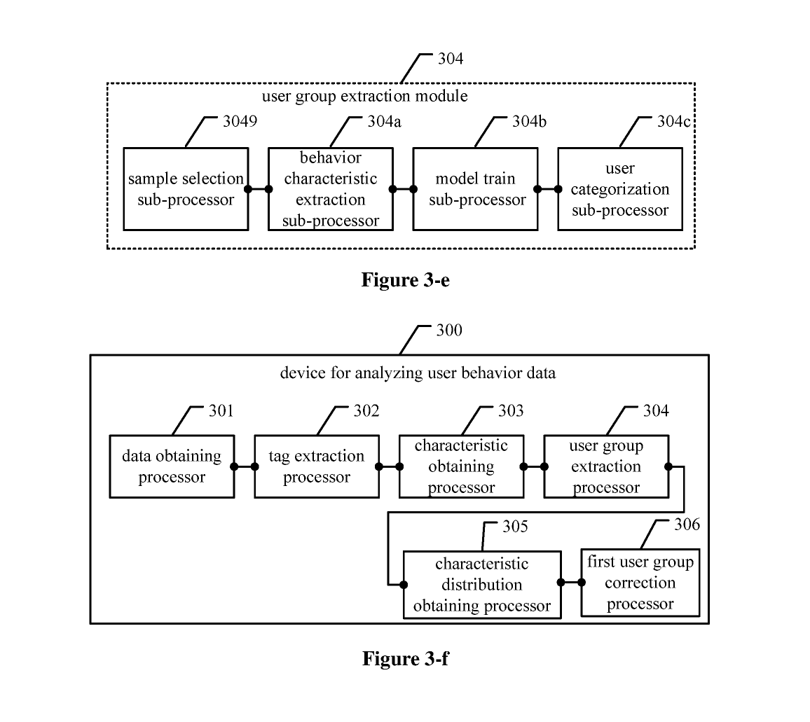

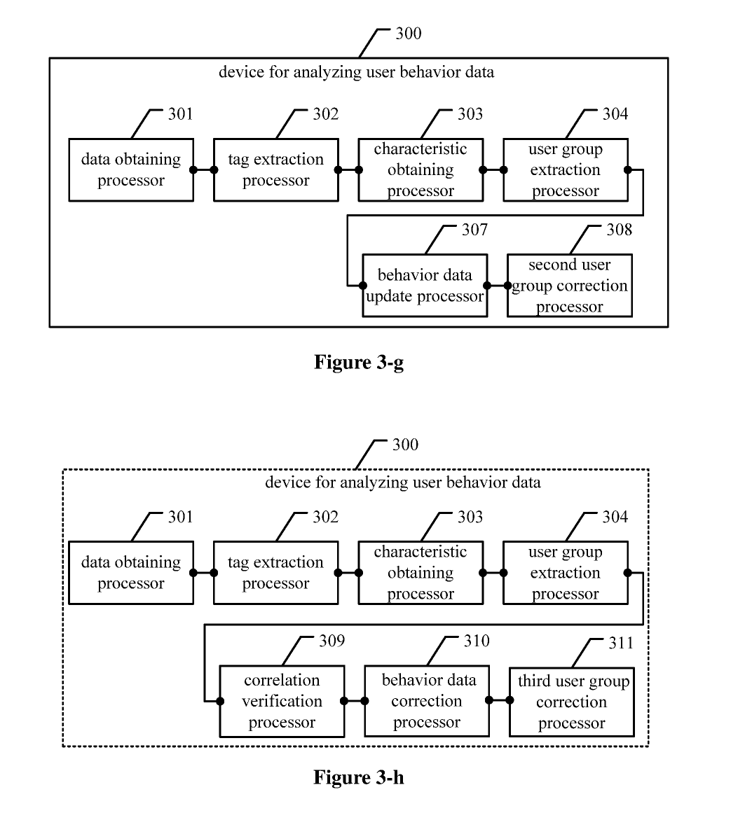

Referring to FIG. 3-a, a device 300 for analyzing user behavior data is provided according to an embodiment of the disclosure. The device may include a data obtaining processor 301, a tag extraction processor 302, a characteristic obtaining processor 303, and a user group extraction processor 304.

The data obtaining processor 301 is configured to obtain behavior data generated by a user in a data source after the user registers with the data source. The data source includes behavior data generated by each user that register with the data source and the behavior data is data information recording a behavior of a user in the data source.

The tag extraction processor 302 is configured to extract a user tag from the behavior data generated by the user in the data source. The user tag is information representing a behavior of the user.

The characteristic obtaining processor 303 is configured to obtain a preset oriented audience characteristic. The oriented audience characteristic is a characteristic of an audience meeting an oriented characteristic requirement.

The user group extraction processor 304 is configured to extract a target user group meeting the oriented audience characteristic from all users in the data source, based on the behavior data generated by the user in the data source and the user tag. The target user group includes multiple users meeting the oriented audience characteristic.

Compared with the user group extraction processor 304 shown in FIG. 3-a, the user group extraction processor 304 in some embodiments of the disclosure may further include an oriented category extraction sub-processor 3041, a first user behavior statistic sub-processor 3042 and a first user group extraction sub-processor 3043, as shown in FIG. 3-b.

The oriented category extraction sub-processor 3041 is configured to extract an oriented category from classified categories in the data source based on the oriented audience characteristic.

The first user behavior statistic sub-processor 3042 is configured to perform statistics to determine the number of user behaviors, each of which with the user tag meeting the oriented category, in the data source.

The first user group extraction sub-processor 3043 is configured to extract users, each of which with the number of the user behaviors exceeding an oriented category threshold, in the data source, to form a target user group. The target user group includes all users each of which with the number of the user behaviors exceeding the oriented category threshold.

In some other embodiments of the disclosure, the first user behavior statistic sub-processor 3042 is specifically configured to calculate the number number of user behaviors, each of which with the user tag meeting the oriented category, in the data source by using the following formula:

number=Σᵢ₌₁^{N}(λᵢ*Σⱼ₌₁^{M}countⱼ);

where N is the number of data sources, λᵢ is a weight of an i-th data source, M is the number of oriented categories in the i-th data source, and countⱼ is the number of user behaviors of a user in a j-th oriented category in each data source.

Compared with the user group extraction processor 304 shown in FIG. 3-a, the user group extraction processor 304 in some embodiments of the disclosure may further include a keyword obtaining sub-processor 3044, a second user behavior statistic sub-processor 3045, an audience score calculation sub-processor 3046 and a second user group extraction sub-processor 3047, as shown in FIG. 3-c.

The keyword obtaining sub-processor 3044 is configured to obtain a keyword of the oriented audience characteristic based on the oriented audience characteristic.

The second user behavior statistic sub-processor 3045 is configured to match the keyword with the extracted user tag, and calculate the number of all user behaviors, each of which with the user tag being matched with the keyword successfully, in the data source.

The audience score calculation sub-processor 3046 is configured to calculate an oriented audience score of each user having a user behavior with the user tag being matched with the keyword successfully in the data source, based on a forgetting factor and the number of all user behaviors, each of which with the user tag being matched with the keyword successfully, in the data source.

The second user group extraction sub-processor 3047 is configured to extract users, each of which with the oriented audience score exceeding an oriented audience correlation threshold, in the data source, to form the target user group. The target user group includes all users, each of which with the oriented audience score exceeding the oriented audience correlation threshold, in the data source.

Compared with the user group extraction processor 304 shown in FIG. 3-c, the user group extraction processor 304 in some embodiments of the disclosure may further include a filter word obtaining sub-processor 3048, as shown in FIG. 3-d.

The filter word obtaining sub-processor 3048 is configured to obtain a filter word which is related to the keyword but is not matched with the oriented audience characteristic, based on the obtained keyword.

The second user behavior statistic sub-processor 3045 is configured to match the keyword and the filter word with the extracted user tag respectively, and calculate the number of all user behaviors, each of which with the user tag being matched with the keyword successfully but failing to be matched with the filter word, in the data source.

In some other embodiments of the disclosure, the audience score calculation sub-processor 3046 is configured to calculate the oriented audience score score of each user having a user behavior with the user tag being matched with the keyword successfully in the data source, by using the following formula:

$$score = \frac{1}{1 + γ * exp [ - {\sum }_{begin\_time}^{end\_time} {\sum }_{i = 1}^{N} ( {λ}_{i} * {S}_{i} * F ( x ) ) / b ]} ;$$

where N is the number of data sources, λᵢ is a weight of an i-th data source, Sᵢ is the number of user behaviors, each of which with the user tag being matched with the keyword successfully, in the i-th data source, F (X) is the forgetting factor,

$$F ( X ) = {e}^{- \frac{{log}_{2}^{( cur \text{-} est )}}{hl}} ,$$

cur is a current time when calculating score, est is a time when the user behavior is generated, hl is a half-life period, begin_time is a start time of the behavior data recorded in the data source, end_time is an end time of the behavior data recorded in the data source, γ is a control parameter for a range of the oriented audience score, and b is a control parameter for an increment speed of the oriented audience score.

Compared with the user group extraction processor 304 shown in FIG. 3-a, the user group extraction processor 304 in some embodiments of the disclosure may further include a sample selection sub-processor 3049, a behavior characteristic extraction sub-processor 304a, a model train sub-processor 304b, and a user categorization sub-processor 304c, as shown in FIG. 3-e.

The sample selection sub-processor 3049 is configured to select a training sample set from all users in the data source based on the oriented audience characteristic.

The behavior characteristic extraction sub-processor 304a is configured to extract a behavior characteristic from a user tag of a user in the training sample set. A characteristic value of the behavior characteristic is term frequency-inverse document frequency (TF-IDF) of a word representing the behavior characteristic.

The model train sub-processor 304b is configured to train a categorization model with the behavior characteristic by using a categorization method.

The user categorization sub-processor 304c is configured to categorize all users in the data source by the categorization model, to obtain the target user group. The target user group includes all users screened out by the categorization model.

In some other embodiments of the disclosure, the TF-IDF of the behavior characteristic extracted by the behavior characteristic extraction sub-processor 304a is calculated by using the following formula:

$$TFIDF = \frac{tf ( t , d ) * {log}_{2} ( \frac{N}{{n}_{i}} + 0.01 )}{\sqrt{\sum {[ tf ( t , d ) * {log}_{2} ( \frac{N}{{n}_{i}} + 0.01 ) ]}^{2}}} ,$$

where tf (t,d) is the number of user behaviors in the data source, t is a word representing the behavior characteristic, d is the behavior data in the data source, N is the number of user behaviors of all users, and nᵢ is the number of user behaviors of a user selected as the training sample set.

Compared with the device 300 for analyzing user behavior data shown in FIG. 3-a, the device 300 for analyzing user behavior data in some embodiments of the disclosure may further include a characteristic distribution obtaining processor 305 and a first user group correction processor 306, as shown in FIG. 3-f.

The characteristic distribution obtaining processor 305 is configured to obtain an audience characteristic distribution of all users in the target user group.

The first user group correction processor 306 is configured to filter out a user in the target user group exceeding a characteristic distribution range of the audience characteristic distribution, to obtain a first corrected target user group, where the first corrected target user group includes users in the target user group within the characteristic distribution range of the audience characteristic distribution.

Compared with the device 300 for analyzing user behavior data shown in FIG. 3-a, the device 300 for analyzing user behavior data in some embodiments of the disclosure may further include a behavior data update processor 307 and a second user group correction processor 308, as shown in FIG. 3-g.

The behavior data update processor 307 is configured to update the behavior data generated by the user in the data source.

The second user group correction processor 308 is configured to correct the target user group meeting the oriented audience characteristic based on the updated behavior data, to obtain a second corrected target user group.

The second user group correction processor is configured to extract an updated user tag from the updated behavior data, and extract multiple users meeting the oriented audience characteristic based on the updated behavior data and the updated user tag, to form the second corrected target user group.

Compared with the device 300 for analyzing user behavior data shown in FIG. 3-a, the device 300 for analyzing user behavior data in some embodiments of the disclosure may further include a correlation verification processor 309, a behavior data correction processor 310 and a third user group correction processor 311, as shown in FIG. 3-h.

The correlation verification processor 309 is configured to verify a correlation between multiple users in the target user group and the oriented audience characteristic.

The behavior data correction processor 310 is configured to correct the behavior data in the data source corresponding to a user, of which the correlation is less than a correlation threshold, in the target user group.

The third user group correction processor 311 is configured to correct the target user group meeting the oriented audience characteristic based on the corrected behavior data, to obtain a third corrected target user group.

The third user group correction processor is configured to extract a corrected user tag from the corrected behavior data, and extract multiple users meeting the oriented audience characteristic based on the corrected behavior data and the corrected user tag, to form the third corrected target user group.

According to the embodiment of the disclosure, firstly behavior data generated by the user in the data source is obtained after the user registers with the data source and a user tag is extracted from the behavior data generated by the user in the data source, and then a preset oriented audience characteristic is obtained, and finally a target user group meeting the oriented audience characteristic is extracted from all users in the data source based on the behavior data generated by the user in the data source and the user tag. The extracted target user group includes multiple users meeting the oriented audience characteristic. The user behavior analysis can be performed on each user in the data source based on the behavior data generated by the user in the data source and the extracted user tag, which can improve the accuracy for the user behavior analysis. In addition, users meeting the requirement of the oriented audience characteristic may be extracted from all users in the data source based on the set oriented audience characteristic, and all the extracted users meeting the requirement of the oriented audience characteristic form the target user group. Since the oriented audience characteristic can be set based on different requirements of the advertiser, different target user groups are extracted based on different advertisement requirements. For advertisement pushing, the advertisement is pushed to only the target user group meeting the oriented audience characteristic, therefore pertinence of objects to which the advertisement is pushed is improved.

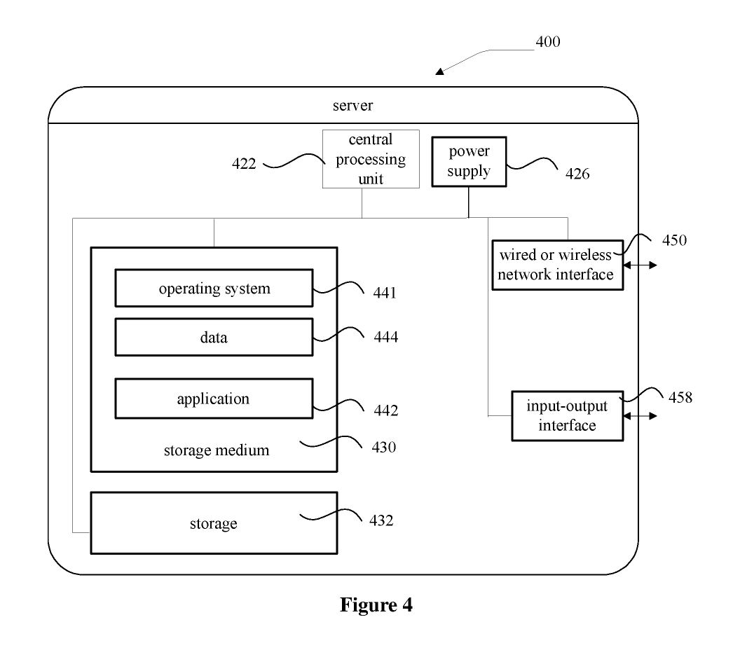

A case that the method for analyzing user behavior data according to the embodiment of the disclosure is applied to a server is taken as example for illustration. Referring to FIG. 4, a structure diagram of a server related to an embodiment of the disclosure is shown. The server 400 may be different due to different configurations or performances. The server 400 may include one or more central processing units (CPU) 422 (for example, one or more processors), a storage 432, and one or more storage media 430 (for example, one or more mass storage device) for storing a storage application 442 or data 444. The storage 432 and the storage medium 430 may be temporary storage or persistent storage.

The application stored in the storage medium 430 may include one or more processors (not shown in the drawings), and each processor may include a series of instruction operations to the server. Furthermore, the central processing unit 422 may be configured to communicate with the storage medium 430, and execute on the server 400 a series of instruction operations in the storage medium 430.

The server 400 may further include one or more power supplies 426, one or more wired or wireless network interfaces 450, one or more input-output interfaces 458, and/or one or more operating systems 441, e.g., Windows Server™, Mac OS X™, Unix™, Linux™, FreeBSD™.

The steps performed by the server described in the forgoing embodiments may be based on the server structure shown in FIG. 4. One or more processors 422 execute the following operation instructions included in the one or more applications:

obtaining behavior data generated by a user in a data source after the user registers with the data source, where the data source includes behavior data generated by each user that registers with the data source and the behavior data is data information recording a behavior of a user in the data source;

extracting a user tag from the behavior data generated by the user in the data source, where the user tag is information representing a behavior of the user;

obtaining a preset oriented audience characteristic, where the oriented audience characteristic is a characteristic of an audience meeting an oriented characteristic requirement; and

extracting a target user group meeting the oriented audience characteristic from all users in the data source, based on the behavior data generated by the user in the data source and the user tag.

Optionally, extracting the target user group meeting the oriented audience characteristic from all users in the data source based on the behavior data generated by the user in the data source and the user tag includes:

extracting an oriented category from classified categories in the data source based on the oriented audience characteristic;

performing statistics to determine the number of user behaviors, each of which with the user tag meeting the oriented category, in the data source; and

extracting users, each of which with the number of the user behaviors exceeding an oriented category threshold, in the data source, to form the target user group, where the target user group includes all users each of which with the number of the user behaviors exceeding the oriented category threshold.

Optionally, performing statistics to determine the number of the user behaviors, each of which with the user tag meeting the oriented category, in the data source includes:

calculating the number number of the user behaviors, each of which with the user tag meeting the oriented category, in the data source by using the following formula:

number=Σᵢ₌₁^{N}(λᵢ*Σⱼ₌₁^{M}countⱼ);

where N is the number of data sources, λᵢ is a weight of an i-th data source, M is the number of oriented categories in the i-th data source, and countⱼ is the number of user behaviors of a user in a j-th oriented category in each data source.

Optionally, extracting the target user group meeting the oriented audience characteristic from all users in the data source based on the behavior data generated by the user in the data source and the user tag includes:

obtaining a keyword of the oriented audience characteristic based on the oriented audience characteristic;

matching the keyword with the extracted user tag, and calculating the number of all user behaviors, each of which with the user tag being matched with the keyword successfully, in the data source;

calculating an oriented audience score of each user having a user behavior with the user tag being matched with the keyword successfully in the data source, based on a forgetting factor and the number of all user behaviors, each of which with the user tag being matched with the keyword successfully, in the data source; and

extracting users, each of which with the oriented audience score exceeding an oriented audience correlation threshold, in the data source, to form the target user group, where the target user group includes all users, each of which the oriented audience score exceeding the oriented audience correlation threshold, in the data source.

Optionally, after obtaining the keyword of the oriented audience characteristic based on the oriented audience characteristic, the operation instructions further include:

obtaining a filter word which is related to the keyword but is not matched with the oriented audience characteristic, based on the obtained keyword.

Matching the keyword with the extracted user tag and calculating the number of all user behaviors, each of which with the user tag being matched with the keyword successfully, in the data source includes:

matching the keyword and the filter word with the extracted user tag respectively; and

calculating the number of all user behaviors, each of which with the user tag being matched with the keyword successfully but failing to be matched with the filter word, in the data source.

Optionally, calculating the oriented audience score of each user having a user behavior with the user tag being matched with the keyword successfully in the data source based on the forgetting factor and the number of all user behaviors, each of which with the user tag being matched with the keyword successfully, in the data source includes:

calculating the oriented audience score score of each user having a user behavior with the user tag being matched with the keyword successfully in the data source by using the following formula:

$$score = \frac{1}{1 + γ * exp [ - {\sum }_{begin\_time}^{end\_time} {\sum }_{i = 1}^{N} ( {λ}_{i} * {S}_{i} * F ( x ) ) / b ]} ;$$

where N is the number of data sources, λᵢ is a weight of an i-th data source, Sᵢ is the number of user behaviors, each of which with the user tag being matched with the keyword successfully, in the i-th data source, F (X) is the forgetting factor,

$$F ( X ) = {e}^{- \frac{{log}_{2}^{( cur \text{-} est )}}{hl}} ,$$

cur is a current time when calculating score, est is a time when the user behavior is generated, hl is a half-life period, begin_time is a start time of the behavior data recorded in the data source, end_time is an end time for the behavior data recorded in the data source, γ is a control parameter for a range of the oriented audience score, and b is a control parameter for an increment speed of the oriented audience score.

Optionally, extracting the target user group meeting the oriented audience characteristic from all users in the data source based on the behavior data generated by the user in the data source and the user tag includes:

selecting a training sample set from all users in the data source based on the oriented audience characteristic;

extracting a behavior characteristic from a user tag of a user in the training sample set, where a characteristic value of the behavior characteristic is TF-IDF of a word representing the behavior characteristic;

training a categorization model with the behavior characteristic by using a categorization method; and

categorizing all users in the data source by the categorization model, to obtain the target user group, where the target user group includes all user screened out by the categorization model.

Optionally, the TF-IDF is calculated by using the following formula:

$$TFIDF = \frac{tf ( t , d ) * {log}_{2} ( \frac{N}{{n}_{i}} + 0.01 )}{\sqrt{\sum {[ tf ( t , d ) * {log}_{2} ( \frac{N}{{n}_{i}} + 0.01 ) ]}^{2}}} ,$$

where tf (t,d) is the number of user behaviors in the data source, t is a word representing the behavior characteristic, d is the behavior data in the data source, N is the number of user behaviors of all users, and nᵢ is the number of user behaviors of a user selected as the training sample set.

Optionally, after extracting the target user group meeting the oriented audience characteristic from all users in the data source based on the behavior data generated by the user in the data source and the user tag, the operation instructions further include:

obtaining an audience characteristic distribution of all users in the target user group; and

filtering out a user in the target user group exceeding a characteristic distribution range of the audience characteristic distribution, to obtain a first corrected target user group, where the first corrected target user group comprises users in the target user group within the characteristic distribution range of the audience characteristic distribution.

Optionally, after extracting the target user group meeting the oriented audience characteristic from all users in the data source based on the behavior data generated by the user in the data source and the user tag, the operation instructions further include:

updating the behavior data generated by the user in the data source; and

correcting the target user group meeting the oriented audience characteristic based on the updated behavior data, to obtain a second corrected target user group.

Correcting the target user group meeting the oriented audience characteristic based on the updated behavior data to obtain the second corrected target user group includes: extracting an updated user tag from the updated behavior data, and extracting multiple users meeting the oriented audience characteristic based on the updated behavior data and the updated user tag, to form the second corrected target user group.

Optionally, after extracting the target user group meeting the oriented audience characteristic from all users in the data source based on the behavior data generated by the user in the data source and the user tag, the operation instructions further include:

verifying a correlation between multiple users in the target user group and the oriented audience characteristic;

correcting behavior data in the data source corresponding to a user, of which the correlation is less than a correlation threshold, in the target user group; and

correcting the target user group meeting the oriented audience characteristic based on the corrected behavior data, to obtain a third corrected target user group.

Correcting the target user group meeting the oriented audience characteristic based on the corrected behavior data, to obtain the third corrected target user group includes:

extracting a corrected user tag from the corrected behavior data, and extracting multiple users meeting the oriented audience characteristic based on the corrected behavior data and the corrected user tag, to form the third corrected target user group.

It should be understood that, the device embodiments described above are merely exemplary. The units described as separate components may be or may be not separated physically. The components shown as units may be or may be not physical units, i.e., the units may be located at one place or may be distributed onto multiple network units. All of or part of the processors may be selected based on actual needs to achieve an object of the solution according to the embodiment of the disclosure. In addition, in the drawings according to the device embodiments of the disclosure, the connection relation between processors indicates communication connection among the processors, which may be realized as one or more communication buses or signal lines. Those skilled in the art may understand and implement the solutions without any creative work.

Based on the embodiments described above, those skilled in the art may clearly realize that, the invention may be implemented through software and required general-purpose hardware. Of course, the invention may be alternatively implemented through specialized hardware, including an application-specific integrated circuit, a dedicated CPU, a dedicated storage, a special component, or the like. In general case, a function accomplished by a computer program may be implemented by corresponding hardware easily, and hardware structure achieving a same function may be different, e.g., an analog circuit, a digital circuit, or a specific circuit. However, it is preferable to implement the solution of the invention through software programs in most cases. Based on such understanding, the technical solutions of the disclosure or a part of the disclosure that contributes to conventional technologies may be embodied in the form of a software product. The computer software product is stored in a readable storage medium such as a floppy disk of a computer, a USB disk, a mobile hard disk drive, a read-only memory (ROM), a random access memory (RAM), a magnetic disk, or an optical disk. The readable storage medium includes several instructions for instructing a computer device (which may be a personal computer, a server, a network device or the like) to implement the methods according to the embodiments of the disclosure.

In conclusion, the forgoing embodiments are merely to illustrate the technical solutions of the disclosure, but not to limit the disclosure. Though the disclosure is described in detail according to the forgoing embodiments, those skilled in the art should understand that, the technical solutions described in the embodiments may be modified, or parts of the technical features may be equivalently substituted. The modification or substitution does not make the essence of corresponding technical solutions depart from the spirit and scope of the technical solutions according to the embodiments of the disclosure.

1. A method for analyzing user behavior data, comprising:
obtaining behavior data generated by a user in a data source after the user registers with the data source, wherein the data source comprises behavior data generated by each user that registers with the data source and the behavior data is data information recording a behavior of a user in the data source;
extracting a user tag from the behavior data generated by the user in the data source, wherein the user tag is information representing a behavior of the user;
obtaining a preset oriented audience characteristic, wherein the oriented audience characteristic is a characteristic of an audience meeting an oriented characteristic requirement; and
extracting a target user group meeting the oriented audience characteristic from all users in the data source, based on the behavior data generated by the user in the data source and the user tag, wherein the target user group comprises multiple users meeting the oriented audience characteristic,
wherein extracting the target user group meeting the oriented audience characteristic from all users in the data source based on the behavior data generated by the user in the data source and the user tag comprises:
extracting an oriented category from classified categories in the data source based on the oriented audience characteristic;
performing statistics to determine the number of user behaviors, each of which with the user tag meeting the oriented category, in the data source; and
extracting users, each of which with the number of the user behaviors exceeding an oriented category threshold, in the data source, to form the target user group, wherein the target user group comprises all users each of which with the number of the user behaviors exceeding the oriented category threshold.

2. (canceled)

3. The method according to claim 1, wherein performing statistics to determine the number of the user behaviors, each of which with the user tag meeting the oriented category, in the data source comprises:
calculating the number of the user behaviors, each of which with the user tag meeting the oriented category, in the data source by using the following formula:
number=Σᵢ₌₁^{N}(λᵢ*Σⱼ₌₁^{M}countⱼ);
wherein number is the number of the user behaviors, N is the number of data sources, λᵢ is a weight of an i-th data source, M is the number of oriented categories in the i-th data source, and countⱼ is the number of user behaviors of a user in a j-th oriented category in each data source.

4. The method according to claim 1, wherein extracting the target user group meeting the oriented audience characteristic from all users in the data source based on the behavior data generated by the user in the data source and the user tag comprises:
obtaining a keyword of the oriented audience characteristic based on the oriented audience characteristic;
matching the keyword with the extracted user tag, and calculating the number of all user behaviors, each of which with the user tag being matched with the keyword successfully, in the data source;
calculating an oriented audience score of each user having a user behavior with the user tag being matched with the keyword successfully in the data source, based on a forgetting factor and the number of all user behaviors, each of which with the user tag being matched with the keyword successfully, in the data source; and
extracting users, each of which with the oriented audience score exceeding an oriented audience correlation threshold, in the data source, to form the target user group, wherein the target user group comprises all users, each of which with the oriented audience score exceeding the oriented audience correlation threshold, in the data source.

5. The method according to claim 4, wherein after obtaining the keyword of the oriented audience characteristic based on the oriented audience characteristic, the method further comprises:
obtaining a filter word which is related to the keyword but is not matched with the oriented audience characteristic, based on the obtained keyword;
and wherein matching the keyword with the extracted user tag and calculating the number of all user behaviors, each of which with the user tag being matched with the keyword successfully, in the data source, comprises:
matching the keyword and the filter word with the extracted user tag respectively; and calculating the number of all user behaviors, each of which with the user tag being matched with the keyword successfully but failing to be matched with the filter word, in the data source.

6. The method according to claim 4, wherein calculating the oriented audience score of each user having a user behavior with the user tag being matched with the keyword successfully in the data source based on the forgetting factor and the number of all user behaviors, each of which with the user tag being matched with the keyword successfully, in the data source, comprises:
calculating the oriented audience score of each user having a user behavior with the user tag being matched with the keyword successfully in the data source, by using the following formula:
$$score = \frac{1}{1 + γ * exp [ - {\sum }_{begin\_time}^{end\_time} {\sum }_{i = 1}^{N} ( {λ}_{i} * {S}_{i} * F ( x ) ) / b ]} ;$$
wherein score is the oriented audience score, N is the number of data sources, λᵢ is a weight of an i-th data source, Sᵢ is the number of user behaviors, each of which with the user tag being matched with the keyword successfully, in the i-th data source, F(X) is the forgetting factor,
$$F ( X ) = {e}^{- \frac{{log}_{2}^{( cur \text{-} est )}}{hl}} ,$$
cur is a current time when calculating score, est is a time when the user behavior is generated, hl is a half-life period, begin_time is a start time of the behavior data recorded in the data source, end_time is an end time of the behavior data recorded in the data source, γ is a control parameter for a range of the oriented audience score, and b is a control parameter for an increment speed of the oriented audience score.

7. The method according to claim 1, wherein extracting the target user group meeting the oriented audience characteristic from all users in the data source based on the behavior data generated by the user in the data source and the user tag comprises:
selecting a training sample set from all users in the data source based on the oriented audience characteristic;
extracting a behavior characteristic from a user tag of a user in the training sample set, wherein a characteristic value of the behavior characteristic is a term frequency-inverse document frequency (TF-IDF) of a word representing the behavior characteristic;
training a categorization model with the behavior characteristic using a categorization method; and
categorizing all users in the data source by the categorization model, to obtain the target user group, wherein the target user group comprises all users screened out by the categorization model.

8. The method according to claim 7, wherein the TF-IDF is calculated by using the following formula:
$$TFIDF = \frac{tf ( t , d ) * {log}_{2} ( \frac{N}{{n}_{i}} + 0.01 )}{\sqrt{\sum {[ tf ( t , d ) * {log}_{2} ( \frac{N}{{n}_{i}} + 0.01 ) ]}^{2}}} ,$$
wherein tf(t,d) is the number of user behaviors in the data source, t is a word representing the behavior characteristic, d is the behavior data in the data source, N is the number of user behaviors of all users, and nᵢ is the number of user behaviors of a user selected as the training sample set.

9. The method according to claim 1, wherein after extracting the target user group meeting the oriented audience characteristic from all users in the data source based on the behavior data generated by the user in the data source and the user tag, the method further comprises:
obtaining an audience characteristic distribution of all users in the target user group; and
filtering out a user in the target user group exceeding a characteristic distribution range of the audience characteristic distribution, to obtain a first corrected target user group, wherein the first corrected target user group comprises users in the target user group within the characteristic distribution range of the audience characteristic distribution.

10. The method according to claim 1, wherein after extracting the target user group meeting the oriented audience characteristic from all users in the data source based on the behavior data generated by the use in the data source and the user tag, the method further comprises:
updating the behavior data generated by the user in the data source; and
correcting the target user group meeting the oriented audience characteristic based on the updated behavior data, to obtain a second corrected target user group.

11. The method according to claim 10, wherein correcting the target user group meeting the oriented audience characteristic based on the updated behavior data to obtain the second corrected target user group comprises:
extracting an updated user tag from the updated behavior data, and extracting multiple users meeting the oriented audience characteristic based on the updated behavior data and the updated user tag, to form the second corrected target user group.

12. The method according to claim 1, wherein after extracting the target user group meeting the oriented audience characteristic from all users in the data source based on the behavior data generated by the user in the data source and the user tag, the method further comprises:
verifying a correlation between multiple users in the target user group and the oriented audience characteristic;
correcting behavior data in a data source corresponding to a user, of which the correlation is less than a correlation threshold, in the target user group; and
correcting the target user group meeting the oriented audience characteristic based on the corrected behavior data, to obtain a third corrected target user group.

13. The method according to claim 12, wherein correcting the target user group meeting the oriented audience characteristic based on the corrected behavior data to obtain the third corrected target user group comprises:
extracting a corrected user tag from the corrected behavior data, and extracting multiple users meeting the oriented audience characteristic based on the corrected behavior data and the corrected user tag, to form the third corrected target user group.

14. A device for analyzing user behavior data, comprising:
a data obtaining processor, configured to obtain behavior data generated by a user in a data source after the user registers with the data source, wherein the data source comprises behavior data generated by each user that registers with the data source and the behavior data is data information recording a behavior of a user in the data source;
a tag extraction processor, configured to extract a user tag from the behavior data generated by the user in the data source, wherein the user tag is information representing a behavior of the user;
a characteristic obtaining processor, configured to obtain a preset oriented audience characteristic, wherein the oriented audience characteristic is a characteristic of an audience meeting an oriented characteristic requirement; and
a user group extraction processor, configured to extract a target user group meeting the oriented audience characteristic from all users in the data source, based on the behavior data generated by the user in the data source and the user tag, wherein the target user group comprises multiple users meeting the oriented audience characteristic,
wherein the user group extraction processor comprises:
an oriented category extraction sub-processor, configured to extract an oriented category from classified categories in the data source based on the oriented audience characteristic;
a first user behavior statistic sub-processor, configured to perform statistics to determine the number of user behaviors, each of which with the user tag meeting the oriented category, in the data source; and
a first user group extraction sub-processor, configured to extract users, each of which with the number of the user behaviors exceeding an oriented category threshold, in the data source, to form the target user group, wherein the target user group comprises all users each of which with the number of the user behaviors exceeding the oriented category threshold.

15. (canceled)

16. The device according to claim 14, wherein the first user behavior statistic sub-processor is configured to calculate the number of the user behaviors, each of which with the user tag meeting the oriented category, in the data source by using the following formula:
number=Σᵢ₌₁^{N}(λᵢ*Σⱼ₌₁^{M}countⱼ);
wherein number is the number of the user behaviors, N is the number of data sources, λᵢ is a weight of an i-th data source, M is the number of oriented categories in the i-th data source, and countⱼ is the number of user behaviors of a user in a j-th oriented category in each data source.

17. The device according to claim 14, wherein the user group extraction processor comprises:
a keyword obtaining sub-processor, configured to obtain a keyword of the oriented audience characteristic based on the oriented audience characteristic;
a second user behavior statistic sub-processor, configured to match the keyword with the extracted user tag, and calculate the number of all user behaviors, each of which with the user tag being matched with the keyword successfully, in the data source;
an audience score calculation sub-processor, configured to calculate an oriented audience score of each user having a user behavior with the user tag being matched with the keyword successfully in the data source, based on a forgetting factor and the number of all user behaviors, each of which with the user tag being matched with the keyword successfully, in the data source; and
a second user group extraction sub-processor, configured to extract users, each of which with the oriented audience score exceeding an oriented audience correlation threshold, in the data source, to form the target user group, wherein the target user group comprises all users, each of which with the oriented audience score exceeding the oriented audience correlation threshold, in the data source.

18. The device according to claim 17, wherein the user group extraction processor further comprises a filter word obtaining sub-processor, wherein
the filter word obtaining sub-processor is configured to obtain a filter word which is related to the keyword but is not matched with the oriented audience characteristic, based on the obtained keyword; and
the second user behavior statistic sub-processor is configured to match the keyword and the filter word with the extracted user tag respectively; and calculate the number of all user behaviors, each of which with the user tag being matched with the keyword successfully but failing to be matched with the filter word, in the data source.

19. The device according to claim 17, wherein the audience score calculation sub-processor is configured to calculate the oriented audience score of each user having a user behavior with the user tag being matched with the keyword successfully in the data source, by using the following formula:
$$score = \frac{1}{1 + γ * exp [ - {\sum }_{begin\_time}^{end\_time} {\sum }_{i = 1}^{N} ( {λ}_{i} * {S}_{i} * F ( x ) ) / b ]} ;$$
wherein score is the oriented audience score, N is the number of data sources, λᵢ is a weight of an i-th data source, Sᵢ is the number of user behaviors, each of which with the user tag being matched with the keyword successfully, in the i-th data source, F(X) is the forgetting factor,
$$F ( X ) = {e}^{- \frac{{log}_{2}^{( cur \text{-} est )}}{hl}} ,$$
cur is a current time when calculating score, est is a time when the user behavior is generated, hl is a half-life period, begin_time is a start time of the behavior data recorded in the data source, end_time is an end time of the behavior data recorded in the data source, γ is a control parameter for a range of the oriented audience score, and b is a control parameter for an increment speed of the oriented audience score.

20. The device according to claim 19, wherein the user group extraction processor comprises:
a sample selection sub-processor, configured to select a training sample set from all users in the data source based on the oriented audience characteristic;
a behavior characteristic extraction sub-processor, configured to extract a behavior characteristic from a user tag of a user in the training sample set, wherein a characteristic value of the behavior characteristic is a term frequency-inverse document frequency (TF-IDF) of a word representing the behavior characteristic;
a model train sub-processor, configured to a categorization model with the behavior characteristic using a categorization method; and
a user categorization sub-processor, configured to categorize all users in the data source by the categorization model, to obtain the target user group, wherein the target user group comprises all users screened out by the categorization model.

21. The device according to claim 20, wherein the TF-IDF of the behavior characteristic extracted by the behavior characteristic extraction sub-processor is calculated by using the following formula:
$$TFIDF = \frac{tf ( t , d ) * {log}_{2} ( \frac{N}{{n}_{i}} + 0.01 )}{\sqrt{\sum {[ tf ( t , d ) * {log}_{2} ( \frac{N}{{n}_{i}} + 0.01 ) ]}^{2}}} ,$$
wherein tf(t,d) is the number of user behaviors in the data source, t is a word representing the behavior characteristic, d is the behavior data in the data source, N is the number of user behaviors of all users, and nᵢ is the number of user behaviors of a user selected as the training sample set.

22. The device according to claim 14, wherein the device for analyzing user behavior data further comprises:
a characteristic distribution obtaining processor, configured to obtain an audience characteristic distribution of all users in the target user group; and
a first user group correction processor, configured to filter out a user in the target user group exceeding a characteristic distribution range of the audience characteristic distribution, to obtain a first corrected target user group, wherein the first corrected target user group comprises users in the target user group within the characteristic distribution range of the audience characteristic distribution.

23. The device according to claim 14, wherein the device for analyzing user behavior data further comprises:
a behavior data update processor, configured to update the behavior data generated by the user in the data source; and
a second user group correction processor, configured to correct the target user group meeting the oriented audience characteristic based on the updated behavior data, to obtain a second corrected target user group.

24. The device according to claim 23, wherein the second user group correction processor is configured to extract an updated user tag from the updated behavior data, and extracting multiple users meeting the oriented audience characteristic based on the updated behavior data and the updated user tag, to form the second corrected target user group.

25. The device according to claim 14, wherein the device for analyzing user behavior data further comprises:
a correlation verification processor, configured to verify a correlation between multiple users in the target user group and the oriented audience characteristic;
a behavior data correction processor, configured to correct behavior data in a data source corresponding to a user, of which the correlation is less than a correlation threshold, in the target user group; and
a third user group correction processor, configured to correct the target user group meeting the oriented audience characteristic based on the corrected behavior data, to obtain a third corrected target user group.

26. The device according to claim 25, wherein the third user group correction processor is configured to extract a corrected user tag from the corrected behavior data, and extract multiple users meeting the oriented audience characteristic based on the corrected behavior data and the corrected user tag, to form the third corrected target user group.
